(19) United States
(12) Patent Application Publication
(10) Pub. No.: US 2015/0099406 A1
(43) Pub. Date: Apr. 9, 2015

(54) STRUCTURE FOR JOINING ELECTRIC WIRE AND TERMINAL, RESISTANCE-WELDING ELECTRODE, AND METHOD FOR JOINING ELECTRIC WIRE AND TERMINAL

(71) Applicant: YAZAKI CORPORATION, Tokyo (JP)

(72) Inventor: Shunya TSUGE, Kakegawa-shi (JP)

(73) Assignee: YAZAKI CORPORATION, Tokyo (JP)

(21) Appl. No.: 14/506,927

(22) Filed: Oct. 6, 2014

(30) Foreign Application Priority Data
Oct. 7, 2013 (JP) 2013-210524

(51) Int. Cl. H01R 4/02; H01R 43/02

(52) U.S. Cl. CPC H01R 4/023; H01R 43/0214
USPC 439/874; 219/56.22

(57) ABSTRACT

A structure for joining an electric wire and a connection terminal by a resistance-welding is provided. The electric wire includes a core wire made of metal. The connection terminal is made of metal different from the metal of the core wire. The core wire includes a melt-joining portion configured to be resistance-welded with the connection terminal. The melt-joining portion has an inclined surface which is inclined so that a thickness of the core wire becomes larger toward a base-end side from a thinnest part of the melt-joining portion along an extending direction in which the core wire extends.

### BACKGROUND

The present invention relates to joining technologies for resistance-welding a core wire of an electric wire to a connection terminal.

Resistance-welding is known as one of the technologies for joining an electric wire and a connection terminal to each other (see Patent Documents 1 and 2). Such resistance-welding causes a contact surface of each electrode to contact a core wire of an electric wire, and melts the core wire with Joule heat generated by applying electric current thereto from the contact surface. Thus, the resistance-welding joins the molten core wire to the connection terminal. Consequently, as compared with arc-welding and gas-welding, a welding operation can relatively easily be performed in the case of resistance-welding.
[Patent Document 1] JP-A-2009-40385
[Patent Document 2] JP-A-2009-123451

### SUMMARY

It is one advantageous aspect of the present invention to provide a technology for joining an electric wire and a terminal, which can stabilize a joining surface by suppressing the production of a metal compound when joining the electric wire and the terminal and also can ensure sufficient electric wire strength at the welded part.

According to one aspect of the invention, there is provided a structure for joining an electric wire and a connection terminal by a resistance-welding, comprising:

an electric wire including a core wire made of metal; and

a connection terminal made of metal different from the metal of the core wire,

wherein the core wire includes a melt-joining portion configured to be resistance-welded with the connection terminal, and

the melt-joining portion has an inclined surface which is inclined so that a thickness of the core wire becomes larger toward a base-end side from a thinnest part of the melt-joining portion along an extending direction in which the core wire extends.

The structure may be configured such that: the connection terminal includes a connection portion configured to be electrically connected to a connection-counterpart-side component of the electric wire, and a core wire joining portion configured to be resistance-welded with the melt-joining portion; the connection portion extends parallel to the extending direction of the core wire; and the core wire joining portion is inclined with respect to the connection portion.

According to another aspect of the invention, there is provided a resistance-welding electrode for resistance-welding a core wire of an electric wire to a connection terminal, comprising:

a contact surface configured to be contacted with at least one of a melt-joining portion of the core wire and the connection terminal when the core wire is resistance-welded with the connection terminal, wherein

the contact surface is gradually inclined along an extending direction, in which the core wire extends, from a part most protruded toward the melt-joining portion or the connection terminal.

According to another aspect of the invention, there is provided a method for joining an electric wire and a connection terminal, the method comprising

forming an inclined surface on a melt-joining portion of a core wire of the electric wire so that the melt-joining portion is inclined so as to become gradually thicker toward a base-end side from a thinnest part of the melt-joining portion along an extending direction in which the core wire extends; and

resistance-welding the melt-joining portion with a connection terminal.

The forming of the inclined surface may be performed while performing the resistance-welding.

### BRIEF DESCRIPTION OF DRAWINGS

FIGS. 1A, 1B, and 1C are views illustrating a structure for joining an electric wire and a terminal according to a first embodiment of the invention. FIG. 1A is a perspective view illustrating an arrangement of a core wire, a connection terminal, and electrodes. FIG. 1B is a cross-sectional view illustrating a state in which the core wire is joined to the connection terminal at the resistance-welding. FIG. 1C is a view enlargedly illustrating an inside of a region indicated by a dot-dash-line shown in FIG. 1B.

FIGS. 2A and 2B are views illustrating a configuration of the connection terminal according to the first embodiment of the invention. FIG. 2A is a perspective view illustrating the entire connection terminal. FIG. 2B is a side view illustrating the connection terminal.

FIGS. 3A and 3B are views illustrating a configuration of the connection terminal according to a modification of the first embodiment of the invention. FIG. 3A is a perspective view illustrating the entire connection terminal. FIG. 3B is a side view illustrating the connection terminal.

FIG. 4 is a view partly enlargedly illustrating a state in which the core wire is joined to the connection terminal according to a modification of the first embodiment when the core wire is resistance-welded to the connection terminal.

FIGS. 5A, 5B, and 5C are views illustrating a joining structure of an electric wire and a terminal according to a second embodiment of the invention. FIG. 5A is a cross-sectional view illustrating a state in which a core wire is joined to the connection terminal at the resistance-welding. FIG. 5B is a view enlargedly illustrating an inside of a region indicated by a dot-dash-line shown in FIG. 5A. FIG. 5C is a view illustrating a configuration of an electrode.

FIGS. 6A and 6B are views illustrating a structure for joining an electric wire and a terminal according to a modification of the second embodiment of the invention. FIG. 6A is a view illustrating a configuration of an electrode. FIG. 6B is a cross-sectional view illustrating a state in which a core wire is joined to the connection terminal at the resistance-welding.

### DETAILED DESCRIPTION OF EXEMPLIFIED EMBODIMENTS

In the case of resistance-welding a joining member and a joined member respectively made of different metals, a metal compound is produced in a joining layer between both the members when joining the members. For example, if a core wire of an aluminum electric wire is resistance-welded to a copper connection terminal, a metal compound made of aluminum and copper is produced in the joining layer. However, the metal compound made of aluminum and copper is hard, brittle, and vulnerable to shock. Therefore, it is undesirable to use an electric wire and a connection terminal that have a joining layer made of such a metal compound, in an environment in which an external pressure is applied to the electric wire and the connection terminal. Accordingly, a joining method is desired, according to which such a metal compound is not produced. Or it is desired that even if such a metal compound is produced, the thickness of a compound layer is controlled to be as thin as possible (i.e., to be equal to or less than 1 μm).

Further, in the case of resistance-welding a joining member (core wire of an electric wire) to a joined member (connection terminal) with electrodes each having, e.g., a flat-shaped (flat-like) contact surface, the core wire is uniformly molten, so that the diameter of the molten core wire is extremely decreased. Accordingly, for example, if a force (pull force) in a direction of ripping a welded part of the core wire from the connection terminal acts on the electric wire, stress due to the pull force is excessively loaded on a part which is relatively small in the diameter of the core wire, as compared with other parts (parts whose core wires have usual diameters). Thus, it is difficult to ensure strength (electric wire strength) at the welded part of the core wire.

The invention is accomplished in view of this problem. One of objects of the invention is to provide a technology for joining an electric wire and a terminal, which can stabilize a joining surface by suppressing the production of a metal compound when joining the electric wire and the terminal and also can ensure sufficient electric wire strength at the welded part.

Hereinafter, a structure for joining an electric wire and a terminal according to the invention is described with reference to the accompanying drawings. The invention provides a method for resistance-welding a core wire of an electric wire to a connection terminal to thereby join the core wire and the connection terminal respectively made of different metals. Specifically, while forming an inclined surface that is inclined so that a melt-joining portion of the core wire becomes thicker from a thinnest part of the melt-joining portion toward a base-end side along an extending direction in which the core wire extends, the melt-joining portion is resistance-welded to the connection terminal. A description is given hereinafter of the configuration of each of a terminal joining structure for an electric wire, a connection terminal, and resistance-welding electrodes (hereinafter referred to simply as electrodes) used in this joining structure to implement such a method for joining an electric wire to a terminal.

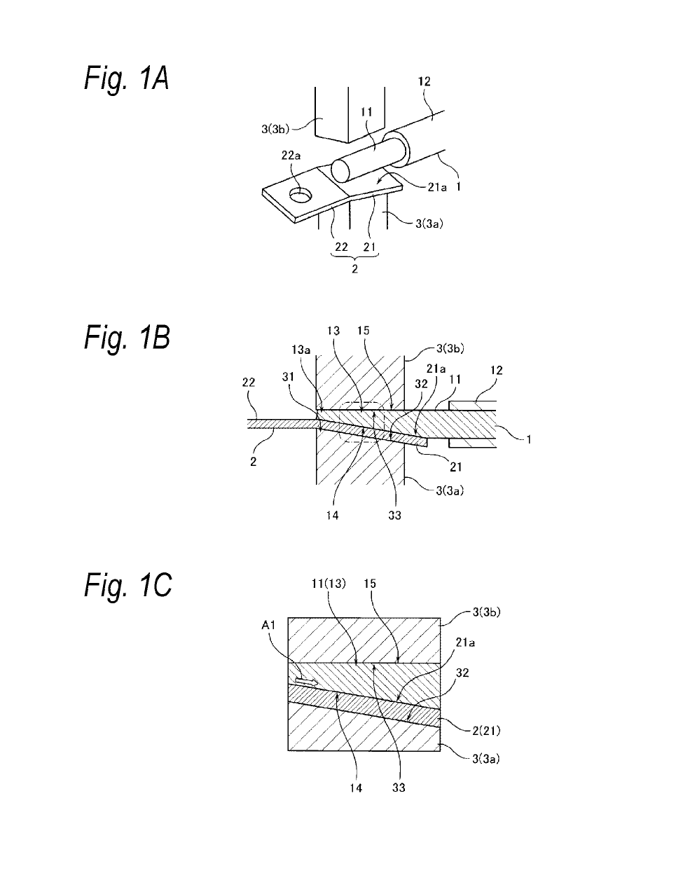

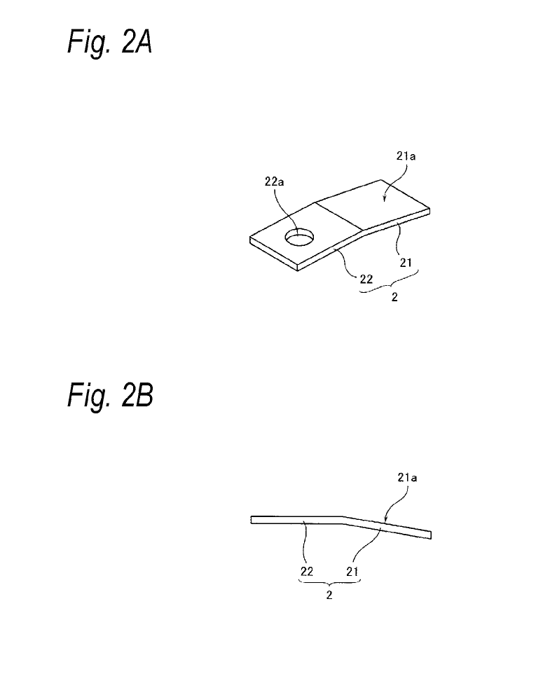

FIGS. 1A to 1C illustrate a structure for joining an electric wire 1 and a terminal according to a first embodiment of the invention. FIG. 1A is a perspective view illustrating an arrangement of a core wire 11, a connection terminal 2, and electrodes 3. FIG. 1B is a cross-sectional view illustrating a state in which the core wire 11 is joined to the connection terminal 2 when the core wire 11 is resistance-welded to the connection terminal 2. FIG. 10 is a view enlargedly illustrating an inside of a region indicated by a dot-dash-line shown in FIG. 1B. Further, FIGS. 2A and 2B illustrate a configuration of the connection terminal 2 according to the first embodiment of the invention. FIG. 2A is a perspective view illustrating the entire connection terminal 2. FIG. 2B is a side view illustrating the connection terminal 2. Incidentally, in the following description, a lateral direction in FIGS. 1B and 1C is referred to as an extending direction of the core wire 11 (sometimes referred to simply as an extending direction). A left side of each of FIGS. 1B and 10 is referred to as a tip-end side of the core wire 11 (sometimes referred to simply as a tip-end side). A right side of each of FIGS. 1B and 1C is referred to as a base-end side of the core wire 11 (sometimes referred to simply as a bases-end side). Further, upward and downward directions in FIGS. 1B and 1C correspond to the direction of thickness of the core wire 11. An underside in these directions is referred to as an underside or a joining side. A topside in these directions is referred to as a topside or an anti-joining side.

As illustrated in FIGS. 1A to 1C, the electric wire 1 according to the embodiment is configured by coating the core wire 11 with an insulating coating 12. Before resistance-welded to the connection terminal 2, the electric wire 1 is put into a state, in which the core wire 11 is exposed, by peeling off the insulating coating 12. The exposed core wire 11 is placed on a core wire joining portion 21 of the connection terminal 2 (in a state illustrated in FIG. 1A). The core wire 11 may be either an electrically-conductive single metal wire or multiple wires (e.g., plural twisted wires obtained by twisting element wires). Incidentally, FIG. 1A illustrates a configuration example in the case of resistance-welding the core wire 11 to the core wire joining portion 21 without changing the shape (i.e., a substantially cylindrical shape) of the core wire 11 and without shaping the core wire 11 exposed by peeling off the insulating coating 12. However, the core wire 11 may preliminarily be pressed (i.e., preformed) into a predetermined shape (e.g., a flat shape or a rectangular parallelepiped shape).

The core wire 11 is such that an inclined surface 14 is formed on a melt-joining portion 13 of the core wire 11, and that the melt-joining portion 13 is resistance-welded to the core wire joining portion 21 of the connection terminal 2. The inclined surface 14 is formed to be inclined so that the melt-joining portion 13 becomes gradually thicker toward the base-end side along the extending direction from a thinnest part 13a of the melt-joining portion 13. In this case, the core wire 11 is molten when resistance-welded to the connection terminal 2. Then, the joining side (underside) of the melt-joining portion 13 is formed in a tapered manner. The surface formed in a tapered manner is formed as the inclined surface 14. On the other hand, the anti-joining side of the melt-joining portion 13 is formed flat. An anti-joining surface 15 is formed on such an anti-joining side.

Further, the connection terminal 2 is formed by processing an electrically conductive metal plate. The connection terminal 2 is configured to have a connection portion 22 to be electrically connected to a connection-counterpart component (not shown) of the electric wire 1, and also have the core wire joining portion 21 to which the melt-joining portion 13 of the core wire 11 is resistance-welded. The connection portion 22 is formed parallel to the extending direction of the core wire 11. The core wire joining portion 21 is formed to be inclined to the connection portion 22. Particularly, the core wire joining portion 21 is continuous with and inclined to the connection portion 22 formed flat so that the core wire joining portion 21 is formed like a descending slope with a joined surface 21a facing upward. Thus, when the core wire 11 is resistance-welded to the connection terminal 2, the melt-joining portion 13 is joined to the core wire joining portion 21 on the inclined surface 14 while the inclined surface 14 is formed on the melt-joining portion 13 along the inclination of the core wire joining portion 21. Further, in a state in which the melt-joining portion 13 is joined to the core wire joining portion 21 in this manner, the connection portion 22 and the core wire 11 (broadly speaking, the connection terminal 2 and the electric wire 1) can be made to be continuous with each other substantially like a straight line in the extending direction. Accordingly, for example, the flexibility and the workability at the time of connecting the electric wire 1 to a connection-counterpart component can be improved. Incidentally, a through-hole 22a for being connected to the connection-counterpart component is formed in the connection portion 22.

Here, it is noted that if a contact surface of the electrode 3 (e.g., a contact surface 32 of a receiving electrode 3a) is formed to be inclined, the melt-joining portion 13 can be joined to the core wire joining portion 21, while the melt-joining portion 13 is formed to become gradually thicker toward the base-end side, even if the connection terminal 2 is formed without inclining the core wire joining portion 21 to the connection portion 22 (e.g., even if the core joining portion 21 and the connection portion 22 are formed flat to be continuous with each other). Consequently, effects of suppressing an amount of a molten core wire and a quantity of a produced metal compound at the resistance-welding, as will be described below, can be obtained. Accordingly, although the connection terminal 2 is not necessarily formed by inclining the core wire joining portion 21 to the connection portion 22, if the core wire joining portion 21 is formed to be inclined to the connection portion 22 formed flat along the extending direction, the connection portion 22 and the core wire 11 (thus, the connection terminal 2 and the electric wire 1) resistance-welded to each other can be formed to be continuous with each other in the extending direction substantially like a straight line, even in a case where the melt-joining portion 13 is formed to become thicker toward the base-end side at the resistance-welding (in other words, the inclined surface 14 is formed on the melt-joining portion 13).

The electrodes 3 are configured by placing a receiving electrode (e.g., an electrode located at a lower-side part of FIG. 1B) 3a and a movable electrode (e.g., an electrode located at an upper-part of FIG. 1B) 3b opposite to each other as paired electrodes. The electrodes 3 are such that when the core wire 11 is resistance-welded to the connection terminal 2, the connection terminal 2 is placed on the receiving electrode 3a, and the core wire 11 is placed on the connection terminal 2, that then, the core wire 11 is sandwiched between the receiving electrode 3a and the movable electrode 3b together with the connection terminal 2 and pressed, and that electric-power is applied between the electrodes 3a and 3b. The core wire 11 is molten by Joule heat (resistance-heat) produced in this way, and joined to the connection terminal 2.

The receiving electrode 3a has a contact surface 32 to be contacted with the core wire joining portion 21 of the connection terminal 2 when the core wire 11 is resistance-welded to the connection terminal 2. The contact surface 32 is formed to become gradually inclined along the extending direction from a portion (hereinafter referred to as a most protruding portion) 31 most protruding toward the melt-joining portion 13 of the core wire 11. More specifically, the receiving electrode 3a is configured so that the most protruding portion 31 is upwardly protruded toward the melt-joining portion 13 at a tip-end side portion, and that the contact surface 32 is inclined to descend from the most protruding portion 31. In this case, the inclination angle (representing inclination to the extending direction) of the contact surface 32 is set to be the same angle as the inclination angle (representing inclination to the connection portion 22) of the core wire joining portion 21. On the other hand, the movable electrode 3b has a contact surface 33 to be contacted with the melt-joining portion 13 of the core wire 11 when the core wire 11 is resistance-welded to the connection terminal 2, and that the contact surface 33 is formed flat along the extending direction.

Because the inclination angle of the contact surface 32 is matched with the inclination angle of the core wire joining portion 21, the posture of the connection terminal 2 at the time of resistance-welding the core wire 11 to the connection terminal 2 can be stabilized by placing the core wire joining portion 21 on the contact surface 32 in order to resistance-weld the core wire 11 to the connection terminal 2. Next, the melt-joining portion 13 of the core wire 11 is placed on the joined surface 21a of such a core wire joining portion 21a. Then, the movable electrode 3b is caused to descend from above such a melt-joining portion 13 to thereby make the contact surface 33 contact with the anti-joining side of the melt-joining portion 13. In this state, electric current is applied from the contact surface 33 to the melt-joining portion 13 to energize the melt-joining portion 13 while the melt-joining portion 13 is pressed by the contact surface 33 of the movable electrode 3b. Then, the melt-joining portion 13 thus energized is molten by being resistance-heated.

In the connection terminal 2 according to the embodiment, the core wire joining portion 21 is formed to be inclined to the connection portion 22. Therefore, when the melt-joining portion 13 is pressed toward the core wire joining portion 21 by the contact surface 33, the applied pressure (that is, stress generated in the melt-joining portion 13) becomes higher toward the tip-end side and lower toward the base-end side. Accordingly, the amount of resistance-heat generated in the melt-joining portion 13 becomes larger toward the tip-end side and lower toward the base-end side. That is, such an applied pressure (stress) and an amount of resistance-heat are not uniform in the melt-joining portion 13 serving as a joining part and can be dispersed.

At the resistance-welding, sometimes, a metal compound (an example is a compound of aluminum and copper if the core wire 11 is made of aluminum while the connection terminal 2 is made of copper) is produced between the melt-joining portion 13 and the core wire joining portion 21. However, even when such a metal compound is produced, the pressure applied to the melt-joining portion 13 by the contact surface 33 is reduced toward the tip-end side from the base-end side according to this embodiment. The produced metal compound can be made to flow (disperse) from the tip-end side, at which the applied pressure is high, to the base-end side along the inclination (see a state indicated by arrow A1 in FIG. 1C). Thus, the produced metal compound can be removed (drained) from between the melt-joining portion 13 and the core wire joining portion 21. Consequently, a metal compound can be suppressed from being produced in a joining layer between the melt-joining portion 13 and the core wire joining portion 21. Then, the inclined surface 14 extending along the inclination of the core wire joining portion 21 is formed on the melt-joining portion 13. The melt-joining portion 13 is joined to the core wire joining portion 21 along the inclined surface 14. That is, the molten core wire 11 is shaped along the inclination of the core wire joining portion 21 to form the inclined surface 14. In addition, an anti-joining surface (flat surface extending along the extending direction) 15 extending along the contact surface 33 is formed on the anti-joining side (topside) of the melt-joining portion 13. Thus, the melt-joining portion 13 is formed so that the melt-joining portion 13 is shaped by setting a tip-end side terminal portion as the thinnest part 13a so as to become gradually thicker toward the base-end side (see FIG. 1B).

Accordingly, in the melt-joining portion 13, at the tip-end side at which the applied pressure (stress) and the amount of resistance-heat are relatively large, the metal compound can be made to flow toward the base-end side due to a pressure difference. At the base-end side at which the applied pressure (stress) and the amount of resistance-heat are relatively small, the amount of the molten core wire 11 and the quantity of the produced metal compound can be suppressed. Thus, the thickness can be assured. Consequently, the core wire 11 can be resistance-welded to the core wire joining portion 21 with sufficient joining strength and sufficient electric wire over the entire melt-joining portion 13 in the extending direction. Incidentally, if the melt-joining portion 13 and the core wire joining portion 21 (broadly speaking, the core wire 11 and the connection terminal 2) have an electrically conductive property and are respectively made of different metals, the materials of the melt-joining portion 13 and the core wire joining portion 21 are not limited to a specific material. For example, the core wire 11 is made of aluminum, and the connection terminal 2 is made of copper, and vice versa. Alternatively, another electrically conductive metal can optionally be selected and used.

Here, it is noted that although the core wire joining portion 21 has only one inclined portion inclined to the connection portion 22 in the connection terminal 2 according to this embodiment, the core wire joining portion may be configured to have two or more inclined portions each of which is inclined to the connection portion 22. In this case, it is advisable to configure the receiving electrode 3a, corresponding to the configuration of the core wire joining portion having two or more inclined portions, so that, practically, plural parts of the contact surface are inclined to extend along all of the inclined portions of such a core wire joining portion, respectively.

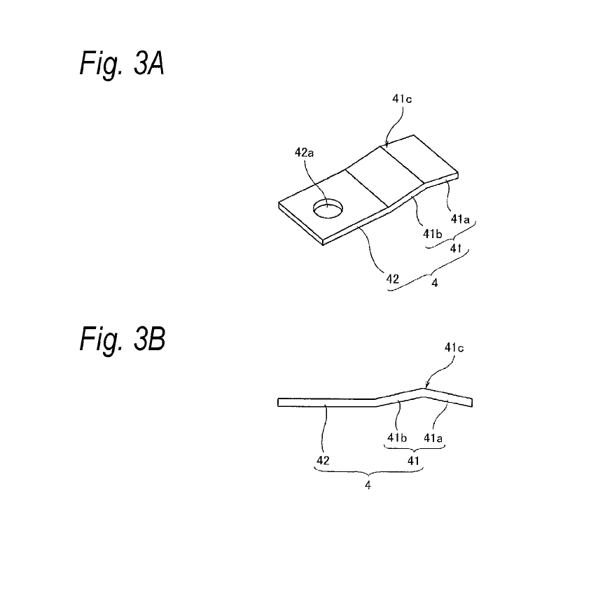

For example, FIGS. 3A and 3B illustrate a configuration of a connection terminal 4 including a core wire joining portion 41 that has two inclined portions respectively inclined to a connection portion 42 (i.e., a first inclined portion 41a and a second inclined portion 41b), as a first modification of this embodiment. The connection terminal 4 is configured such that the second inclined portion 41b of the core wire joining portion 41 is formed like an ascending slope with a joined surface 41c facing upward and inclined to the connection portion 42 formed flat to extend in the extending direction, and that the first inclined portion 41a is formed like a descending slope inclined from a top-end portion to be continuous with the second inclined portion 41b.

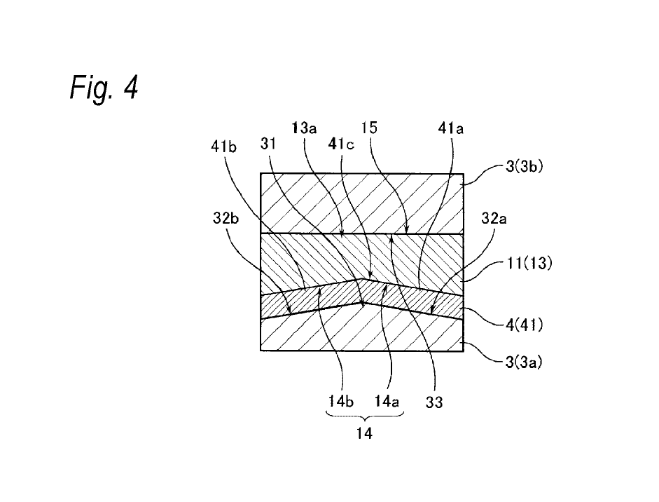

Consequently, when the core wire 11 is resistance-welded to the connection terminal 4, the melt-joining portion 13 is joined to the core wire joining portion 41 along the inclined surfaces 14a and 14b while not only the first inclined surface 14a extending along the first inclined portion 41a is formed on the melt-joining portion 13 but the second inclined surface 14b extending along the second inclined portion 41b is formed, as illustrated in FIG. 4. That is, the melt-joining portion 13 may be configured to have the first inclined surface 14a and the second inclined surface 14b so that the joining portion 13 becomes thicker toward each of the base-end side and the tip-end side along the extending direction from the thinnest part 13a serving as a boundary. Incidentally, the connection terminal 4 may have the same configuration as that of the second terminal 2 illustrated in FIGS. 2A and 2B except that the connection terminal 4 has two inclined portions (i.e., the first inclined portion 41a and the second inclined portion 41b). In the connection portion 42, a through-hole 42a for being connected to the connection-counterpart component is formed in the same manner as the connection terminal 2.

Further, in this case, as illustrated in FIG. 4, the receiving electrode 3a is configured to incline a first contact surface 32a and a second contact surface 32b which are formed like descending slopes at the base-end side and the tip-end side, respectively, from the most protruding portion 31 serving as a boundary. The inclination angle (representing inclination to the extending direction) of the first contact surface 32a is set to be the same angle as the inclination angle (representing inclination to the connection portion 42) of the first inclined portion 41a of the core wire joining portion 41. The inclination angle of the second contact surface 32b is set to be the same angle as the inclination angle of the second inclined portion 41b.

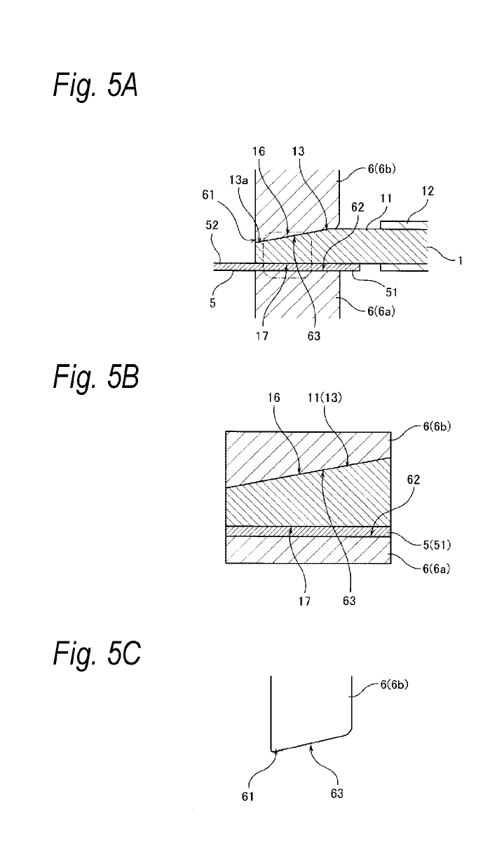

The above first embodiment is configured such that the inclined surface 14 is formed at the joining side (underside) of the melt-joining portion 13. However, even if an inclined surface is formed at the anti-joining side (topside) of the melt-joining portion 13, such a melt-joining portion can be made to become thicker toward the base-end side along the extending direction from the thinnest part of the melt-joining portion. Thus, advantages similar to those of the above first embodiment can be obtained. Hereinafter, the configuration of each of a terminal joining structure in which while an inclined surface is formed at an anti-joining side of a melt-joining portion, the melt-joining portion is joined to the core wire joining portion at a side opposite to the inclined surface (i.e., at a joining side), and a connection terminal and electrodes used in the terminal joining structure is described as a second embodiment of the invention. Incidentally, although the second embodiment differs from the first embodiment in the shape of the resistance-welded melt-joining portion, the configuration of the electric wire according to the second embodiment may be the same as that of the electric wire according to the first embodiment. Therefore, in the drawings, each component of the electric wire according to the second embodiment is designated with the same reference numeral as used to designate a corresponding component according to the first embodiment. Thus, the description of such components is omitted. According to the second embodiment, the extending direction (the tip-end side, and the base-end side), and the upward and downward directions (the joining side and the anti-joining side) are defined as the lateral direction, and the upward and downward directions in FIGS. 5A and 5B, similarly to the first embodiment.

FIGS. 5A to 5C illustrate a structure for joining an electric wire 1 and a terminal according to the second embodiment of the invention. FIG. 5A is a cross-sectional view illustrating a state in which the core wire 11 is joined to a connection terminal 5. FIG. 5B is a view enlargedly illustrating an inside of a region indicated by a dot-dash-line shown in FIG. 5A. FIG. 5C is a view illustrating a configuration of an electrode 6 (i.e., a movable electrode 6b).

The melt-joining portion 13 according to this embodiment is such that a joining side (underside) is shaped flat to extend along the extending direction. On the other hand, an anti-joining side (topside) is formed in a tapered manner. Consequently, an inclined surface 16 is formed at an anti-joining side. In addition, the melt-joining portion 13 is configured to be joined to a core wire joining portion 51 of the connection terminal 5 along a flat joining surface 17 formed at a side (joining side) opposite to the inclined surface 16.

The connection terminal 5 is formed by processing an electrically conductive metal plate. The connection terminal 5 is such that a core wire joining portion 51, to which the core wire 11 of the electric wire 1 is resistance-welded, and a connection portion 52 to be electrically connected to a connection-counterpart component (not shown) of the electric wire 1, are continuous with each other and formed like a flat plate extending along the extending direction. Consequently, when the core wire 11 is resistance-welded to the connection terminal 5, the melt-joining portion 13 is joined to the core wire joining portion 51 by a joining surface 17 while the joining surface (i.e., a flat surface extending along the extending direction) 17 is formed on the melt-joining portion 13 along the core wire joining portion 51 formed like a flat surface extending along the extending direction.

The electrodes 6 are configured by placing a receiving electrode (an example is an electrode located at a lower-side part of FIG. 5A) 6a and a movable electrode (an example is an electrode located at an upper-part of FIG. 5A) 6b opposite to each other as paired electrodes. Incidentally, it is similar to the electrodes 3 according to the first embodiment that the electrodes 6 are pressed and energized while the electrodes 6 are in a state in which the core wire 11 is sandwiched between the receiving electrode 6a and the movable electrode 6b together with the connection terminal 5, and that the core wire 11 is molten by resistance-heat, and melt-joined to the connection terminal 5.

The movable electrode 6b has a contact surface 63 to be contacted with the melt-joining portion 13 of the core wire 11 during the resistance-welding. The contact surface 63 is formed to become gradually inclined along the extending direction from a portion (the most protruding portion) 61 most protruding toward the melt-joining portion 13 of the core wire 11. More specifically, the movable electrode 6b is configured so that the most protruding portion 61 is downwardly protruded toward the melt-joining portion 13 at a tip-end side end portion, and that the contact surface 63 is inclined to ascend from the most protruding portion 61. On the other hand, the receiving electrode 6a has a contact surface 62 to be contacted with the core wire joining portion 51 of the connection terminal 5 at the resistance-welding, and that the contact surface 62 is formed flat along the extending direction.

When the core wire 11 is resistance-welded to the connection terminal 5, the core wire joining portion 51 is placed on the contact surface 62 of the receiving electrode 6a so that the joining portion 51 and the contact surface 62 lay flat to each other. The melt-joining portion 13 of the core wire 11 is placed on such a core wire joining portion 51. Next, the movable electrode 6b is descended from above such a melt-joining portion 13, so that the most protruding portion 61 of the contact surface 63 is made to abut against the anti-joining side of the melt-joining portion 13. When the movable electrode 6b in this state is more descended, the contact surface 63 is contacted with the anti-joining side of the melt-joining portion 13 while the melt-joining portion 13 is pressed by the contact surface 63. Then, electric current is applied from the contact surface 63 to the melt-joining portion 13 to energize the melt-joining portion 13, the melt-joining portion 13 energized in this manner is molten by being resistance-heated.

The movable electrode 6b according to this embodiment is such that the contact surface 63 is inclined from the most protruding portion 61 so as to serve as an ascending slope. Thus, the molten core wire 11 is shaped along the inclination of the contact surface 63 so that the inclined surface 16 is formed on the melt-joining portion 13. On the other hand, the connection terminal 5 is such that the core wire joining portion 51 is formed flat, together with the connection portion 52, along the extending direction. Thus, the molten core wire 11 is shaped flat along the core wire joining portion 51. The contact surface 17 is formed on the underside of the melt-joining portion 13. Accordingly, the melt-joining portion 13 is formed to become thicker toward the base-end side from the tip-end side end portion set to be the thinnest part 13a (see FIG. 5A).

In this case, similarly to the above first embodiment, an applied pressure (that is, stress generated in the melt-joining portion 13) for pressing the melt-joining portion 13 toward the core wire joining portion 51 by the contact surface 63, and an amount of resistance-heat are not uniform at the melt-joining portion 13 serving as a joining part and can be dispersed. That is, in the melt-joining portion 13, at the tip-end side at which the applied pressure (stress) and the amount of resistance-heat are relatively large, the metal compound can be made to flow toward the base-end side due to a pressure difference. At the base-end side at which the applied pressure (stress) and the amount of resistance-heat are relatively small, the amount of the molten core wire 11 and the quantity of the produced metal compound can be suppressed. Thus, the thickness can be assured. Consequently, the core wire 11 can be resistance-welded to the core wire joining portion 51 with sufficient joining strength and sufficient electric wire over the entire melt-joining portion 13 in the extending direction.

Here, it is noted that although the movable electrode 6b according to this embodiment is such that the contact surface 63 is configured to include a single inclined surface, the contact surface of the movable electrode may be configured to include two or more inclined surfaces (or configured to incline two or more parts of the contact surface). In this case, it is advisable to form the contact surface of the receiving electrode flat along the extending direction. Alternatively, the contact surface of the movable electrode may be configured to include at least one inclined surface, and to be formed flat along the extending direction.

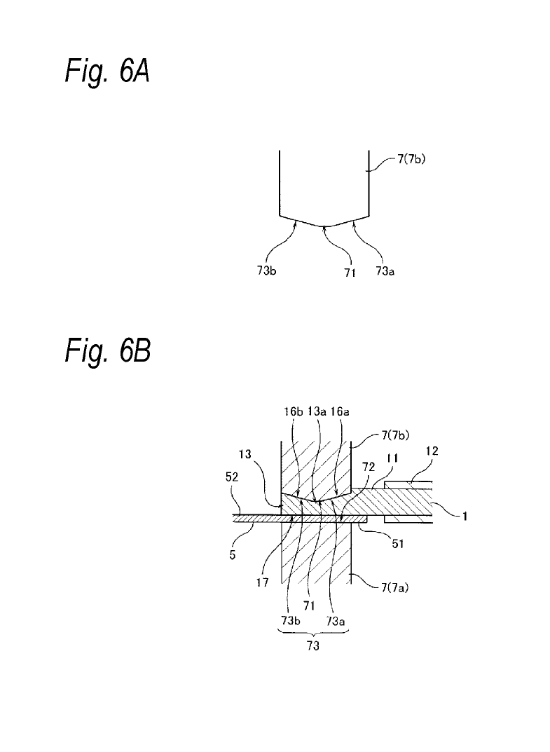

For example, FIG. 6A illustrates a configuration of the movable electrode 7b having a contact surface 73 configured to include two inclined surfaces (i.e., a first contact surface 73a and a second contact surface 73b) as a modification of this embodiment. Incidentally, in this case, as illustrated in FIG. 6B, a contact surface 72 of a receiving electrode 7a is formed flat along the extending direction.

The contact surface 73 is configured as follows. That is, a most protruding portion 71 is downwardly protruded at a substantially middle portion in the extending direction toward the melt-joining portion 13. And, the first contact surface 73a is inclined to serve as an ascending slope extending from the most protruding portion 71 to the tip-end side. In addition, the second inclined surface 73b is inclined to serve as an ascending slope toward the tip-end side from the most protruding portion 71. That is, the contact surface 73 is configured so that the first contact surface 73a and the second contact surface 73b are formed as ascending slopes extending toward the base-end side and the tip-end side, respectively, along the extending direction from the most protruding portion 71 serving as a boundary. Incidentally, the location of the most protruding portion 71 is not limited to the substantially middle portion in the extending direction and may be set to a location deviated to the base-end side or the tip-end side.

Consequently, when the core wire 11 is resistance-welded to the connection terminal 5, the melt-joining portion 13 is joined to the core wire joining portion 51 by the joining surface 17 formed flat along the core wire joining portion 51 under the melt-joining portion 13 while not only the first inclined surface 16a extending along the first contact surface 73a is formed on the melt-joining portion 13 but the second inclined surface 16b extending along the second contact surface 73b is formed, as illustrated in FIG. 6B. That is, the melt-joining portion 13 may be configured to have the first inclined surface 16a and the second inclined surface 16b so that the melt-joining portion 13 becomes gradually thicker toward each of the base-end side and the tip-end side along the extending direction from the thinnest part 13a serving as a boundary.

Thus, the invention has been described with reference to each of the embodiments illustrated in FIGS. 1A to 6B. However, each of the above embodiments is only illustrative of the invention. The invention is not limited to the configuration of each of the above embodiments. Therefore, it is apparent to those skilled in the art that the invention can be implemented in manners changed or modified without departing from the spirit and scope of the invention. It is natural that such modified or changed embodiments belong to the claims appended to the present application.

In the present invention, the melt-joining portion can be formed to become thicker toward the base end from the thinnest part, and can be joined to the connection terminal. Accordingly, in the melt-joining portion, at a tip-end side (i.e., the opposite side of a base-end side) at which a pressure (stress in the melt-joining portion) applied from the electrodes and an amount of resistance-heat are relatively large, a metal compound produced in a joining layer can be made to flow. At the base-end side at which the applied pressure (stress) and the amount of resistance-heat are relatively small, an amount of a molten core wire and a quantity of a produced metal compound can be suppressed to thereby ensure a thickness. Thus, the core wire can be resistance-welded to the connection terminal with sufficient joining strength and electric wire strength over the entire melt-joining portion in the extending direction.

According to the invention, a joining structure of an electric wire and a terminal is implemented, which can suppress, when the electric wire is joined to the terminal, the production of a metal compound to thereby stabilize the joining surface, and which can ensure sufficient electric wire strength at the welded part.

What is claimed is:

1. A structure for joining an electric wire and a connection terminal by a resistance-welding, comprising:
an electric wire including a core wire made of metal; and
a connection terminal made of metal different from the metal of the core wire,
wherein the core wire includes a melt-joining portion configured to be resistance-welded with the connection terminal, and
the melt-joining portion has an inclined surface which is inclined so that a thickness of the core wire becomes larger toward a base-end side from a thinnest part of the melt-joining portion along an extending direction in which the core wire extends.

2. The structure for joining an electric wire and a connection terminal according to claim 1, wherein
the connection terminal includes a connection portion configured to be electrically connected to a connection-counterpart-side component of the electric wire, and a core wire joining portion configured to be resistance-welded with the melt-joining portion,
the connection portion extends parallel to the extending direction of the core wire, and
the core wire joining portion is inclined with respect to the connection portion.

3. A resistance-welding electrode for resistance-welding a core wire of an electric wire to a connection terminal, comprising:
a contact surface configured to be contacted with at least one of a melt-joining portion of the core wire and the connection terminal when the core wire is resistance-welded with the connection terminal, wherein
the contact surface is gradually inclined along an extending direction, in which the core wire extends, from a part most protruded toward the melt-joining portion or the connection terminal.

4. A method for joining an electric wire and a connection terminal, the method comprising
forming an inclined surface on a melt-joining portion of a core wire of the electric wire so that the melt-joining portion is inclined so as to become gradually thicker toward a base-end side from a thinnest part of the melt-joining portion along an extending direction in which the core wire extends; and
resistance-welding the melt-joining portion with a connection terminal.

5. The method according to claim 4, wherein
the forming of the inclined surface is performed while performing the resistance-welding.
